(19) United States
(12) Patent Application Publication
(10) Pub. No.: US 2013/0039000 A1
(43) Pub. Date: Feb. 14, 2013

(54) DOCKING STATION AND ELECTRONIC DEVICE USING THE SAME

(71) Applicants: Domingo A. Vicente, JR., SINGAPORE (SG); Michael Medrano Recinto, SINGAPORE (SG)

(72) Inventors: Domingo A. Vicente, JR., SINGAPORE (SG); Michael Medrano Recinto, SINGAPORE (SG)

(73) Assignees: Cal-Comp Electronics & Communications Company Limited., New Taipei City (TW); AVAPLAS LTD., SINGAPORE (SG)

(21) Appl. No.: 13/232,966

(22) Filed: Sep. 14, 2011

(30) Foreign Application Priority Data
Aug. 12, 2011 (SG) 201105810-4

(51) Int. Cl. G06F 1/16

(52) U.S. Cl. 361/679.41

(57) ABSTRACT

A docking station and an electronic device using the same are provided. The electronic device includes a portable computer and a docking station. The docking station includes a body, a holder and a pivot mechanism. The holder is disposed on the body for containing the portable computer. The pivot mechanism connecting the body and the holder includes a first part and a second part. The first part connects to the body. The second part connects to the holder and pivotly coupled with the first part. The first part includes a first locating portion facing the second part. The second part includes a second locating portion corresponding to the first locating portion. The second locating portion being adapted to engage with the first locating portion for fixing the holder at a desired angle relative to the body as the holder rotating relatively to the body.

### CROSS-REFERENCE TO RELATED APPLICATION

This application claims the priority benefit of Singapore application serial no. 201105810-4, filed Aug. 12, 2011. The entirety of the above-mentioned patent application is hereby incorporated by reference herein and made a part of this specification.

### BACKGROUND

### Field of the Application

Currently, in the era of information explosion, electronic products and daily life have been closely related. With the continuous progress of electronic technology, humanized electronic products with fine functions have been continuously put forward.

With regard to the development and application of personal computers, desktop personal computers (desktop PCs) are firstly developed, but desktop personal computers are quite bulky and cannot be easily carried. Therefore, notebook PCs are then developed. Further, with the advance of science and technology, tablet PCs are then developed.

The tablet PC is convenient in use, and can be placed on an arm, a desk top or even thighs and operated with a stylus in the absence of other accessories, such as a keyboard or a mouse.

However, when additional functions are needed, a user can also install the tablet PC on a docking station for the tablet PC. A keyboard may be disposed on the docking station and a mouse may be linked to the docking station. At this time, the tablet PC can also be operated with the keyboard and the mouse. Furthermore, the docking station can further include a optical disk driver, an expanding hard disk driver, a battery, and so on, so as to provide the functions in addition to press input and cursor control.

### SUMMARY OF THE INVENTION

Accordingly, the present invention is directed to a docking station which can accommodate a portable computer and allow the portable computer rotating and fixing to a desired angle relative to the docking station.

The present invention is directed to an electronic device wherein the portable computer can be detachably installed to the docking station and rotate and fix to a desired angle relative to the docking station.

The present invention provides an electronic device including a portable computer and a docking station. The docking station includes a body, a holder and a pivot mechanism. The holder is disposed on the body for containing the portable computer. The pivot mechanism connects the body. The holder includes a first part and a second part. The first part connects to the body, and the second part connects to the holder and pivotly coupled with the first part. The first part includes a first locating portion facing the second part. The second part includes a second locating portion corresponding to the first locating portion. The second locating portion being adapted to engage with the first locating portion for fixing the holder at a desired angle relative to the body as the holder rotating relatively to the body.

According to an embodiment of the present invention, the first part described above comprises a gouge, the edge of the first part around the gouge comprises a conical portion, and the first locating portion disposed around the conical portion.

According to one embodiment of the present invention, the second part described above comprises a first surface contacting the first part, and a conical through hole for engaging the conical portion, and the second locating portion is disposed on the first surface and around the conical through hole.

According to one embodiment of the present invention, the first locating portion described above comprises at least a bump, and the second locating portion comprises a plurality of recesses.

According to one embodiment of the present invention, the first locating portion described above comprises a plurality of recesses, and the second locating portion comprises at least a bump.

According to one embodiment of the present invention, the second part described above comprises a second surface opposite to the first surface, the pivot mechanism comprises a first washer, a second washer and a spring washer, the first washer is disposed between the second surface and the spring washer, and the spring washer is disposed between the first and the second washer.

According to one embodiment of the present invention, the first washer, the second washer and the spring washer described above respectively comprise a first, a second and a third through holes, and the pivot mechanism further comprises a fastener, fastening to the first part by passing orderly through the third, the second, the first and the conical through holes and then engaging with the gouge.

According to one embodiment of the present invention, the pivot mechanism described above comprises a fastener, fastening to the first part by passing through the second, the third, the fourth and the conical through holes and engaging in the gouge.

According to one embodiment of the present invention, the docking station described above comprises a cap covering the fastener, the spring washer, the first and the second washer and a part of the second part.

According to one embodiment of the present invention, the cap described above includes a hook for hooking the second part.

According to one embodiment of the present invention, the portable computer described above is a tablet PC.

In the docking station and the electronic device using the same provided by the present invention, the pivot mechanism allows the portable computer to rotate relatively to the docking station and be fixed at the desired angle. By doing so, the first part disposed on the holder and the second part disposed on the body engage with each other for which the second part can rotate relatively to the first part. The first part and the second part each comprises a locating portion which can adapt to each other. When the second part rotates to a desired angle relative to the first part, the locating portion of the second part can engage with the corresponding locating portion of the first part to fix the position of the second part relative to the first part. The portable computer accommodated in the holder thus can be fixed at the desired angle relative to the body. Thereby, the portable computer can be easily adjusted to a position which is better for the user use by installed to the docking station which the present invention provides. The convenience and the flexibility of the portable computer can be significantly improved.

In order to make the aforementioned and other objectives, features and advantages of the present invention comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates the electronic device according to an embodiment of the invention.

FIG. 2 illustrates the first part of FIG. 1.

FIG. 3 illustrates the second part of FIG. 1.

FIG. 4 illustrates an exploded view of a part of members of the pivot mechanism of FIG. 1.

FIG. 5 illustrates a cross-sectional view of the pivot mechanism.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

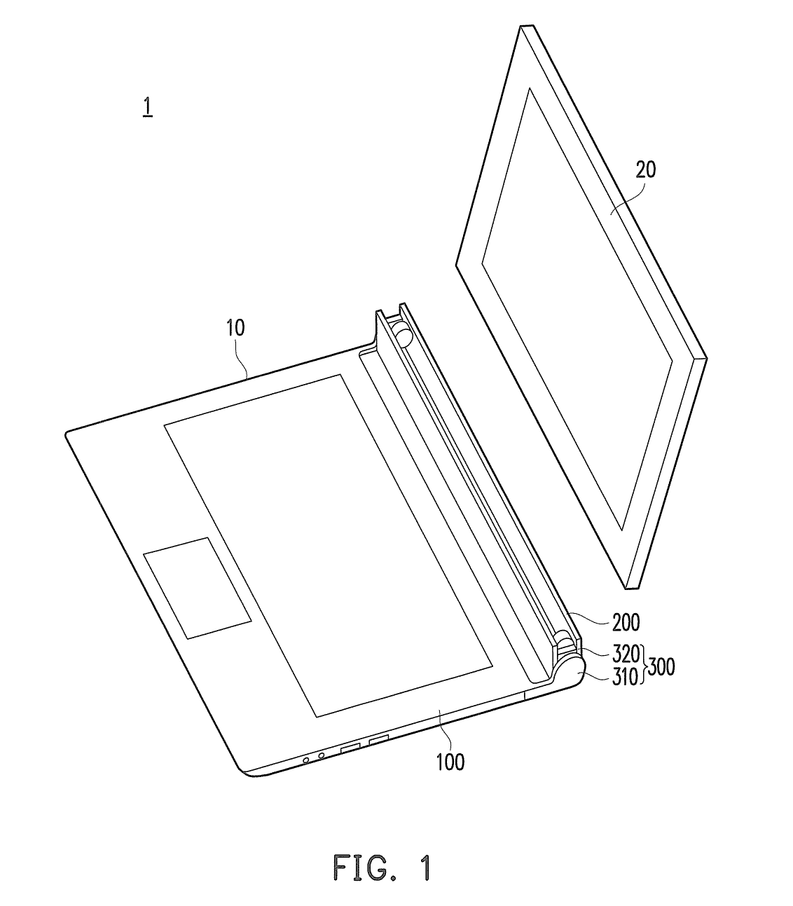

FIG. 1 illustrates the electronic device according to an embodiment of the invention. Please refer to FIG. 1, one embodiment of the electronic device 1 comprises a docking station 10 and a portable computer 20, for example, notebook, tablet PC, etc. In the present embodiment, the portable computer 20 is a tablet PC. The docking station 10 is adapted to accommodate a part of the portable computer 20 for providing the portable computer 20 some peripheral devices such as mouse, printer, external hard drive, network interface adapter (NIC), scanner, etc, so the users of tablet PC can enjoy the same level of the functionality and expandability as the desktop computer offers. For better illustration of the docking station 10, the portable computer 20 is drawn separated from the docking station 10 in FIG. 1. The docking station 10 comprises a body 100, a holder 200, and a pivot mechanism 300. The holder 200 is disposed on the body 100 for accommodating the portable computer 20. The pivot mechanism 300 connects the body 100 and the holder 200, and comprises a first part 310 and a second part 320. The first part 310 connects to the body 100 and the second part 320 connects to the holder 200 and is pivotly coupled with the first part 310 so the holder 200 is suitable for rotating relatively to the body 100.

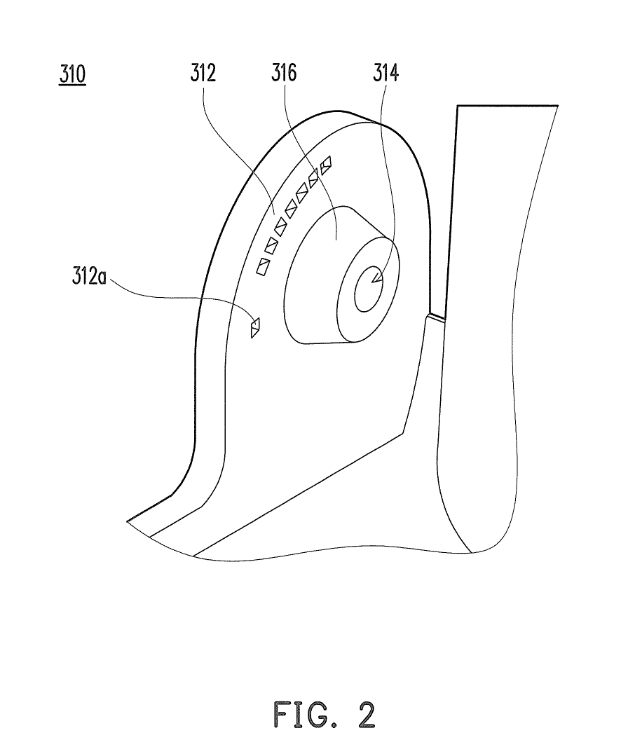

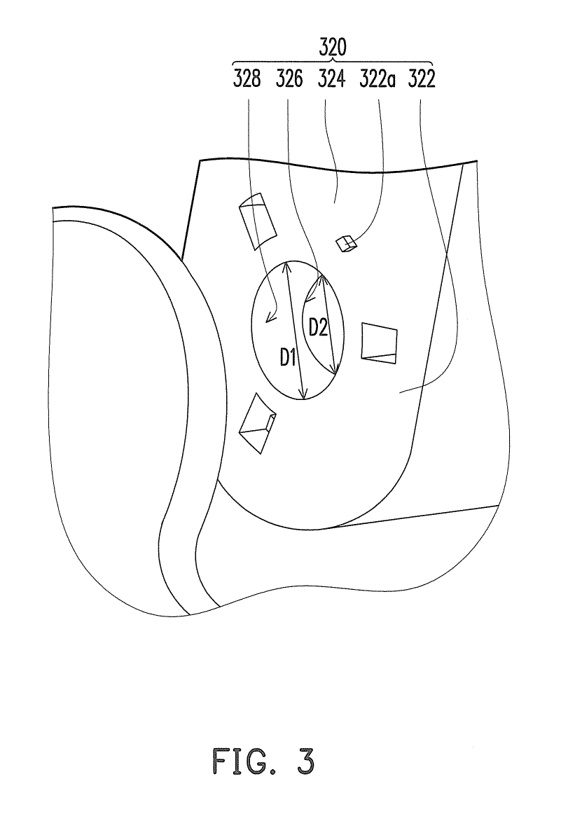

FIG. 2 illustrates the first part of FIG. 1. FIG. 3 illustrates the second part of FIG. 1. Please refer to FIGS. 2 and 3, the first part 310 includes a first locating portion 312 which faces the second part 320. The second part 320 includes a second locating portion 322 which is face the first part 310 and is corresponding to the first locating portion 312. The second locating portion 322 is adapted to engage with the first locating portion 312 so that when the holder 200 rotates to a desired angle A1 relative to the body 100, the first locating portion 312 engages with the second locating portion 322 for fixing the position of the holder 200 relative to the body. In the embodiment of the docking station, the first locating portion 312 includes a plurality of recesses 312a and the second locating portion 322 correspondingly includes at least a bump 322a. The recesses 312a and the bump 322a are suitable for engaging with each other. In other embodiment which is not shown in the drawings of the present invention, the first locating portion 312 includes at least a bump and the second locating portion 322 correspondingly includes a plurality of recesses. People skilled in the art can make some modifications and alteration of the design as long as the first locating portion 312 and the second locating portion 322 is suitable for engaging with each other.

Additionally, the first part 310 further comprises a gouge 314, and a conical portion 316 formed around the gouge 314 and protruded toward the second part 320. The recesses 312a are disposed around the conical portion 316. The second part 320 further comprises a first surface 324, a second surface 326 opposite to the first surface 324 and a conical through hole 328 for engaging with the conical portion 316, so the second part 320 is adapted to rotate relatively to the first part 310. The first surface 324 contacts the first part 310 and the recesses 312a are disposed thereon. The bump 322a is disposed besides the conical through hole 328 corresponding to the recesses 312a. When the second part 320 rotates to a desired angle A1 relative to the first part 310, the at least one bump 322a is adapted to engage with at least one of the recesses 312a which is corresponding to the location of the bump 322a.

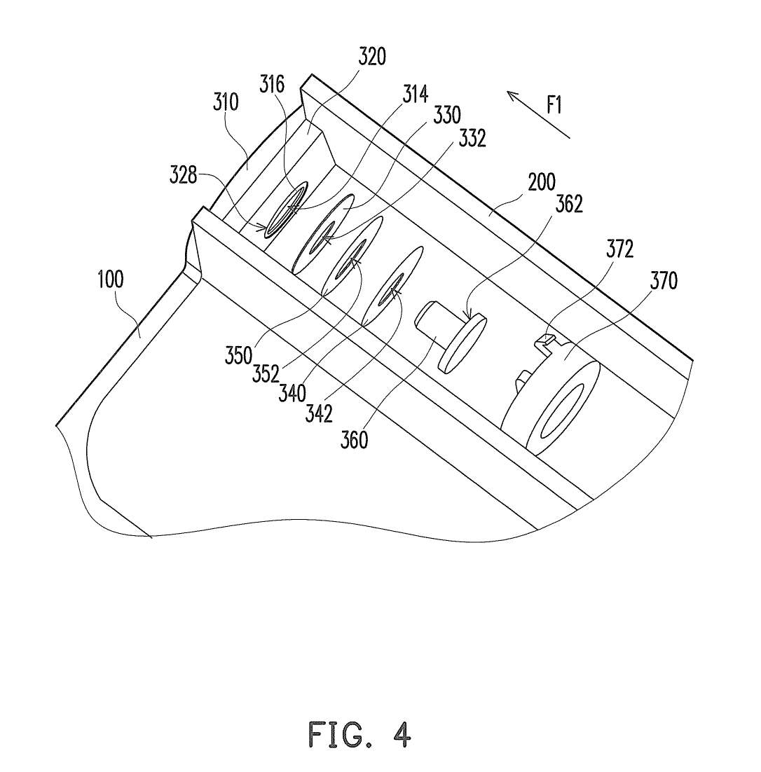

FIG. 4 illustrates an exploded view of a part of members of the pivot mechanism of FIG. 1. Please refer to FIG. 4, the pivot mechanism 300 further comprises a first washer 330, a second washer 340, a spring washer 350, a fastener 360, and a cap 370. The first washer 330 is disposed between the spring washer 350 and the second surface 326. The spring washer 350 is disposed between the first washer 330 and the second washer 340. The first washer 330 comprises a first through hole 332, the second washer 340 comprises a second through hole 342 and the spring washer 350 comprises a third through hole 352.

Additionally, the fastener 360 fastens the first part 310, the second part 320, the first washer 330, the spring washer 350 and the second washer 340 all together by following a fastening direction F1 to pass through the second through hole 340, the third through hole 352, the first through hole 332 and the conical through hole 328 and then engaging with the gouge 314. The fastener 360 includes a contact surface 362 contacting the second washer 340. The cap 360 including a hook 372 covers the fastener 360, the second washer 340, the spring washer 350, the first spring washer 330 and a part of the second part 320, and the hook 372 hooks the second part 320 for fixing the cap 370 to the pivot mechanism 300.

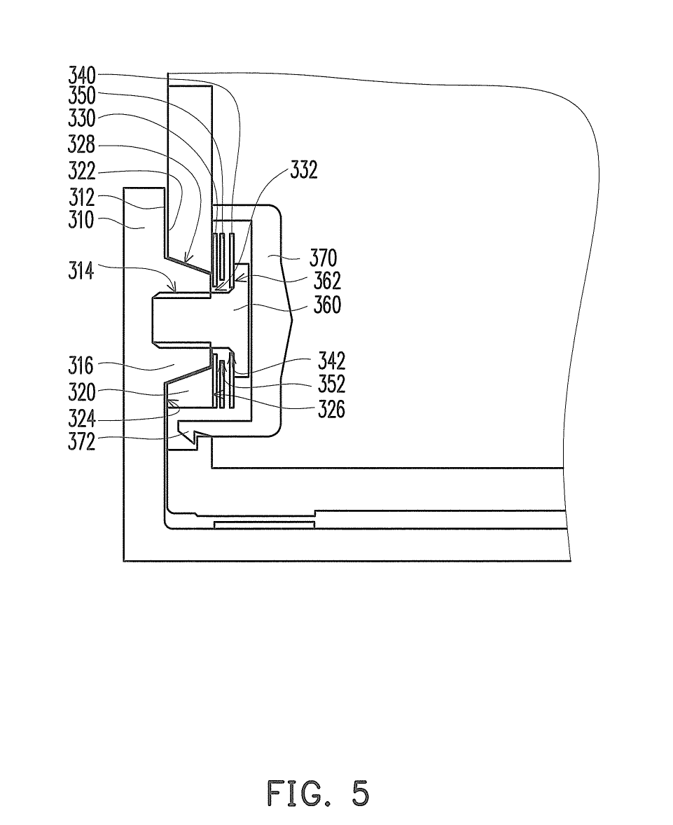

FIG. 5 illustrates a cross-sectional view of the pivot mechanism of FIG. 1. Please refer to FIG. 5, as for assembling the pivot mechanism 300, the conical through hole 328 of the second part 320 firstly engages with the conical portion 316 of the first part 310 so the second part 320 can rotate relatively to the first part 310. The first washer 330 is then disposed on the second surface 326 of the second part 320, and the spring washer 350 is disposed between the first washer 330 and the second washer 340. Therefore, when the second part 320 rotates relatively to the first part 310, the spring washer 350 can provide a norrmal force with the direction of the fastening direction F1 to the conical portion 316, for applying a resisting torque along with the first washer 330 and the second washer 340. The fastener 360 follows the fastening direction F1 to pass through the second through hole 342, the third through hole 352, the first through hole 332, and the conical through hole 328 and then engages with the gouge 314 for fastening the elements of the pivot mechanism 300 together. Finally, the cap 370 covers the fastener 360, the second washer 340, the spring washer 350, the first spring washer 330 and a part of the second part 320 from the user view, and, finally, the hook 372 locks the cap 370 to the second part 320.

In summary, the present invention provides a docking station and an electronic device using the same comprising a pivot mechanism wherein the first part and the second part engage with each other. The first part and the second part each comprises a locating portion. The present invention further applies two washers and a spring washer on the second part. Finally, the fastener passing through the through holes of the washers, spring washers and the second part and engage with the first part.

As the disposition described above, when the portable computer installed on the docking station be rotated to the desired angle by the user, the locating portion of the second part engages with the corresponding locating portion of the first part and locks the position of the second part relative to the first part. Also, when the second part rotates relatively to the first part, friction provided by the two washers and normal force provided by the spring washer apply resisting torque to the second part. The portable computer thus can fix at the desired angle relative to the body. According to the spirit of the present invention, the present invention improves the convenience of portable computers for users.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A docking station, comprising:
a body;
a holder disposed on the body for containing a portable computer; and
a pivot mechanism, connecting the body and the holder, the pivot mechanism comprising;
a first part connecting to the body; and
a second part connecting to the holder and pivotly coupled with the first part, the first part including a first locating portion facing the second part, the second part including a second locating portion corresponding to the first locating portion, the second locating portion being adapted to engage with the first locating portion for fixing the holder at a desired angle relative to the body as the holder rotating relatively to the body.

2. The docking station as claimed in claim 1, wherein the first part comprises a gouge, the edge of the first part around the gouge comprises a conical portion, and the first locating portion disposed around the conical portion.

3. The docking station as claimed in claim 2, wherein the second part comprises a first surface contacting the first part, and a conical through hole for engaging the conical portion, and the second locating portion is disposed on the first surface and around the conical through hole.

4. The docking station as claimed in claim 1, wherein the first locating portion comprises at least a bump, and the second locating portion comprises a plurality of recesses.

5. The docking station as claimed in claim 1, wherein the first locating portion comprises a plurality of recesses, and the second locating portion comprises at least a bump.

6. The docking station as claimed in claim 1, wherein the second part comprises a second surface opposite to the first surface, the pivot mechanism comprises a first washer, a second washer and a spring washer, the first washer is disposed between the second surface and the spring washer, and the spring washer is disposed between the first and the second washer.

7. The docking station as claimed in claim 6, wherein the first washer, the second washer and the spring washer respectively comprise a first, a second and a third through holes, and the pivot mechanism further comprises a fastener, fastening to the first part by passing orderly through the third, the second, the first and the conical through holes and then engaging with the gouge.

8. The docking station as claimed in claim 7, wherein the docking station comprises a cap covering the fastener, the spring washer, the first and the second washer and a part of the second part.

9. The docking station as claimed in claim 8, wherein the cap includes a hook for hooking the second part.

10. The docking station as claimed in claim 1, wherein the portable computer is a tablet PC.

11. An electronic device, comprising:
a portable computer; and
a docking station, comprising:
a body;
a holder disposed on the body for containing the portable computer; and
a pivot mechanism, connecting the body and the holder, the pivot mechanism comprising;
a first part connecting to the body; and
a second part connecting to the holder and pivotly coupled with the first part, the first part including a first locating portion facing the second part, the second part including a second locating portion corresponding to the first locating portion, the second locating portion being adapted to engage with the first locating portion for fixing the holder at a desired angle relative to the body as the holder rotating relatively to the body.

12. The electronic device as claimed in claim 11, wherein the first part comprises a gouge, the edge of the first part around the gouge comprises a conical portion, and the first locating portion disposed around the conical portion.

13. The electronic device as claimed in claim 12, wherein the second part comprises a first surface contacting the first part, and a conical through hole for engaging the conical portion, and the second locating portion is disposed on the first surface and around the conical through hole.

14. The electronic device as claimed in claim 11, wherein the first locating portion comprises at least a bump, and the second locating portion comprises a plurality of recesses.

15. The electronic device as claimed in claim 11, wherein the first locating portion comprises a plurality of recesses, and the second locating portion comprises at least a bump.

16. The electronic device as claimed in claim 11, wherein the second part comprises a second surface opposite to the first surface, the pivot mechanism comprises a first washer, a second washer and a spring washer, the first washer is disposed between the second surface and the spring washer, and the spring washer is disposed between the first and the second washer.

17. The electronic device as claimed in claim 16, wherein the first washer, the second washer and the spring washer respectively comprise a first, a second and a third through holes, and the pivot mechanism further comprises a fastener, fastening to the first part by passing orderly through the third, the second, the first and the conical through holes and then engaging with the gouge.

18. The electronic device as claimed in claim 17, wherein the docking station further comprises a cap covering the fastener, the spring washer, the first and the second washer and a part of the second part.

19. The electronic device as claimed in claim 18, wherein the cap includes a hook for hooking the second part.

20. The electronic device as claimed in claim 11, wherein the portable computer is a tablet PC.
